(19) United States
(12) Patent Application Publication
(10) Pub. No.: US 2022/0172214 A1
(43) Pub. Date: Jun. 2, 2022

(54) METHOD FOR GENERATING TRANSFERABLE TRANCHES

(71) Applicant: Mira FinTech, Inc., The Colony, TX (US)

(72) Inventors: Benayhou BALTSAN, The Colony, TX (US); Lawrence Ira SCHULMAN, Chicago, IL (US)

(73) Assignee: Mira FinTech, Inc., The Colony, TX (US)

(21) Appl. No.: 17/538,654

(22) Filed: Nov. 30, 2021

Related U.S. Application Data
(60) Provisional application No. 63/119,244, filed on Nov. 30, 2020.

(51) Int. Cl. G06Q 20/40; G06Q 20/38; G06Q 40/02

(52) U.S. Cl. CPC G06Q 20/4016; G06Q 40/025; G06Q 20/389

(57) ABSTRACT

A method and system for facilitating direct trading by generating a transferable tranche are provided. A method includes receiving at least one electronic transaction request from a user; computing a risk score of the at least one electronic transaction; responsive to the at least one electronic transaction being allowed based on the risk score, placing the at least one electronic transaction into a transferable transactions queue; and generating a transferable tranche for allocation of the queued electronic transactions.

### CROSS-REFERENCE TO RELATED APPLICATIONS

This application claims the benefit of U.S. Provisional Application No. 63/119,244 filed on Nov. 30, 2020, the contents of which are hereby incorporated by reference.

### TECHNICAL FIELD

The disclosure generally relates to electronic transaction processing systems for generating tranches of transactions.

### BACKGROUND

The electronic monetary transactions market is currently filled with many types of means for payments, such as credit cards, debit cards, stored value cards, loans, Buy Now, Pay Later (BNPL) and the like, all of which may be offered by different issue vendors and providers. Such cards may be physical or virtual (e.g., embedded in a smartphone).

In any such transaction, should the transactor require credit, there is a financial institution that issues the credit card or other means of accessing credit, and is the only provider of the credit or loan. A standard credit card transaction includes paying at a merchant (where the card may be present or not), authorizing the transaction, and sending an authorization to the merchant. The payment is made by the issuer (creditor) to the merchant and later collected from a user (debtor). The authorization is based on the available credit of the debtor and possibly additional fraud detection techniques. However, the authorization is not based on a current risk assessment of whether the debtor can repay. Typically, such a check is performed on the card that is issued to the debtor. However, financial situations may improve or worsen since the card was issued, thus the risk assessment of a debtor may not be current. Currently, there is no method for assessing risk in real time with each incoming transaction.

The current credit model is monopoly based which engenders many disadvantages. One disadvantage of monopoly-based credit models is the high costs passed to both merchants and debtors. For merchants, the creditors charge a certain percentage (commission) of each transaction, and for the debtors, interest is charged on the total unpaid balance. With respect to the merchants, the high commission is justified, in part, on the costs of fraudulent transactions or unpaid transactions. Further, current solutions cause financial damages to merchants as some merchants may be required to reimburse the creditors for fraudulent transactions, or the merchant may have their legitimate transaction denied by the creditors.

Any attempt to determine the risk per transaction using conventional solutions is infeasible as such solutions do not include processes for determining the risk per transaction in real-time, and their compute infrastructure cannot support such transactions. Further, any attempt to offer competing terms to the transactor is infeasible in the current systems due to the inability to have the transactor interact with multiple issuers simultaneously. The current credit model ends up charging transactors (borrowers) interest rates that are not commensurate with the true default risk because of the monopolistic practices in credit offers that exist.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for facilitating direct trading by generating a transferable tranche. The method includes receiving at least one electronic transaction request from a user; computing a risk score of the at least one electronic transaction; responsive to the at least one electronic transaction being allowed based on the risk score, placing the at least one electronic transaction into a transferable transactions queue; and generating a transferable tranche for allocation of the queued electronic transactions.

Certain embodiments disclosed herein include a non-transitory computer readable medium having stored thereon instructions for causing a processing circuitry to perform a process for facilitating direct trading by generating a transferable tranche. The process includes receiving at least one electronic transaction request from a user; computing a risk score of the at least one electronic transaction; responsive to the at least one electronic transaction being allowed based on the risk score, placing the at least one electronic transaction into a transferable transactions queue; and generating a transferable tranche for allocation of the queued electronic transactions.

Certain embodiments disclosed herein include a system for facilitating direct trading by generating a transferable tranche. The system includes: a processing circuitry; and a memory, the memory containing instructions that, when executed by the processing circuitry, configure the system to: receive at least one electronic transaction request from a user; compute a risk score of the at least one electronic transaction; responsive to the at least one electronic transaction being allowed based on the risk score, place the at least one electronic transaction into a transferable transactions queue; and generate a transferable tranche for allocation of the queued electronic transactions.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram depicting the various disclosed embodiments of the transaction processing system.

FIG. 2 is a flow diagram illustrating the monetary transactions according to the disclosed embodiments.

FIG. 3 is a flowchart illustrating a method for assessing a transaction and providing credit according to an embodiment.

FIG. 4 illustrates the generation and maintenance of credit tranches according to an embodiment.

FIG. 5 is an example diagram illustrating the generation of credit tranches according to an embodiment

FIGS. 6A, 6B, and 6C are example diagrams illustrating the maintenance of a credit tranche according to an embodiment.

FIG. 7 is a block diagram of the payment system according to an embodiment.

FIG. 8 is a diagram illustrating the logical functions of the payment system according to an embodiment.

### DETAILED DESCRIPTION

The embodiments disclosed by the invention are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method for generating and managing transferable tranches. In an embodiment, a transferable tranche is a credit tranche which is a novel credit instrument that organizes a series of individual consumers' electronic transactions into an instrument that is standardized according to product specifications such as to general credit quality, the number of transactions, and the total face value of the transactions. The electronic transactions may include payment transaction. The cashflows mirror those of traditional unsecured credit portfolios while allowing the investor to target specific risk levels and minimizing the potential exposure to any one borrower.

The tranches are generated and managed by a tranche engine. In an embodiment, such engine is configured to transform a random flow of transactions into a fixed income instrument with liquidity, transparency and fungibility; enables competition on the credit terms offered to a borrower (consumer), and manages future cash flows related to these transactions. The tranche engine is discussed in more detail below.

The disclosed embodiments for generating and managing tranches are operable in a direct payment system that provides a credit-based purchase without the need for traditional creditors, i.e., credit card issuer. The direct payment system brokers between a merchant (vendor), a debtor, and a creditor while determining the risk per each transaction. The risk is as to whether the transactions would be paid. As such, the disclosed payment system may be designed to increase the number of authorized transactions by reducing the rate of rejected legitimate transactions. As the disclosed payment system may reduce the risk for both creditors and vendors, the financing cost (commission) for transactions can be reduced.

The disclosed system and method provide several technical improvements over prior art solutions. For example, the disclosed system may provide real-time integration between the Payment System and the Credit Tranche Engine. The system operates in real-time and reduces the processing time of transaction review and approval. The disclosed payment system reduces the cycle time for payment execution, improves the reliability of each component, secures the system from fraudulent use, and improves transparency. Further, the disclosed system significantly reduces the number of failures and errors compared to existing solutions. For example, the system might provide the ability to analyze consumers based on data points from several different “Payment systems” if the system can correlate between them.

In some embodiments, a challenger model is provided, where each transaction is evaluated by multiple, competing existing credit risk engines. The results provided by each risk engine are assigned weights using, for example, a machine learning algorithm to arrive at a final risk score. The final risk score is assigned with an expected probability of default from historical data.

In some embodiments, the final risk score is used to place each transaction into a quantile which maps to a tranche risk bucket. The boundaries of the quantiles may be determined by measuring the gradients of differences in probabilities of default mapped to the final risk score. The boundary for each quantile is placed where the gradient is steepest within the acceptable score range.

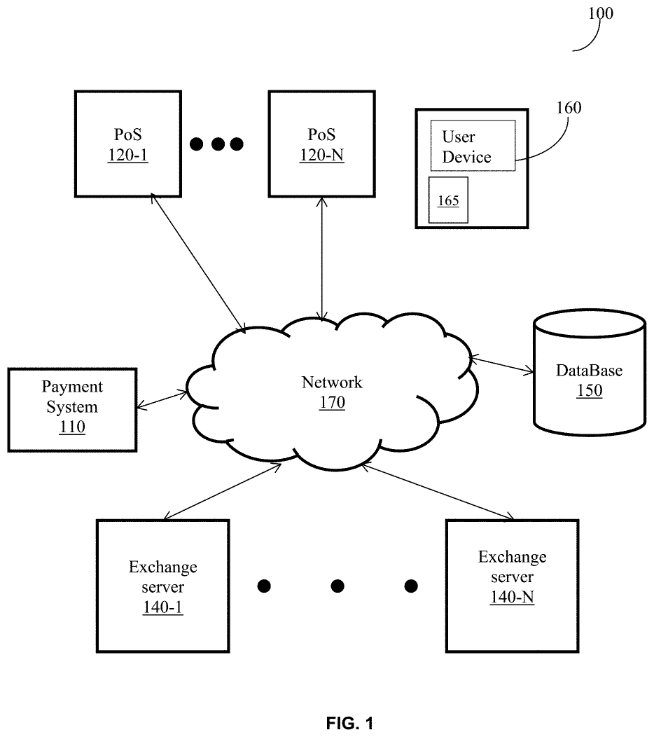

FIG. 1 is an example network diagram 100 depicting the various disclosed embodiments of the payment system. The network diagram 100 illustrates a payment system 110, one or more point of sale (PoS), 120-1 through 120-N (hereinafter, “PoS” 120 or “PoS” 120), one or more financial servers, 140-1 through 140-N (hereinafter “server” 140 or “servers” 140), and a database 150. Further, the various components shown in FIG. 1 are interconnected via a network 170.

The network 170 provides interconnectivity among the various components of the system. The network 170 may be, but is not limited to, a wireless, cellular or wired network, a local area network (LAN), a wide area network (WAN), a metro area network (MAN), the Internet, the worldwide web (WWW), similar networks, and any combination thereof. The network 170 may be a full-physical network, including exclusively physical hardware, a fully-virtual network, including only simulated or otherwise-virtualized components, or a hybrid physical-virtual network, including both physical and virtualized components. Further, the network 170 may be configured to encrypt data, both at rest and in motion, and to transmit encrypted, unencrypted, or partially-encrypted data.

The network 170 may be configured to connect to the various components of the network diagram 100 via wireless means such as, as examples and without limitation, Bluetooth™, long-term evolution (LTE), 5G, Wi-Fi, other, like, wireless means, and any combination thereof, via wired means such as, as examples and without limitation, Ethernet, universal serial bus (USB), other, like wired means, and any combination thereof. Further, the network 170 may be configured to connect with the various components shown in FIG. 1 via any combination of wired and wireless means.

A PoS 120 is a system for processing payments at merchant locations. The PoS 120 may include a dedicated terminal, an application installed on a smartphone or tablet computer, an e-commerce server, and the like. In an embodiment, the PoS 120 includes an agent installed therein and configured to interface with the payment system 110.

In an embodiment, a user (not shown) can make a purchase when the user is present at the retail location, or not. The purchase may be performed by an application or widget installed on a user device. Such an application or widget is configured to interact with the user device.

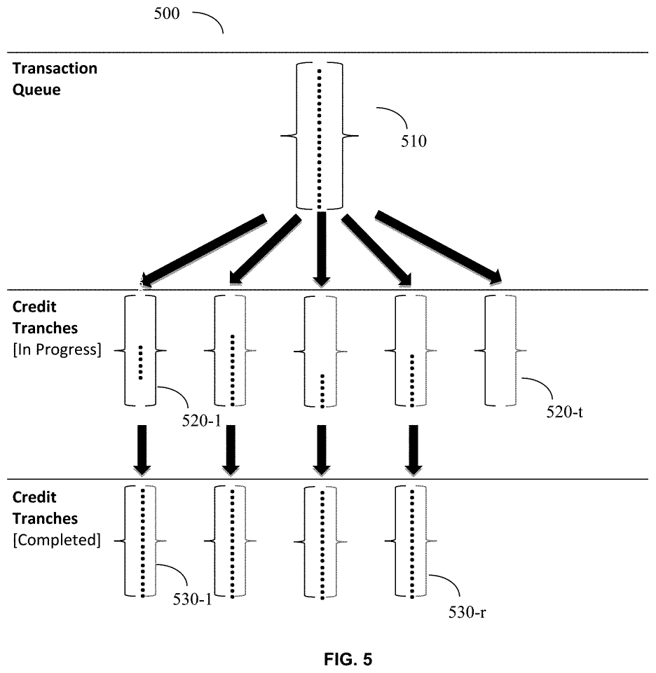

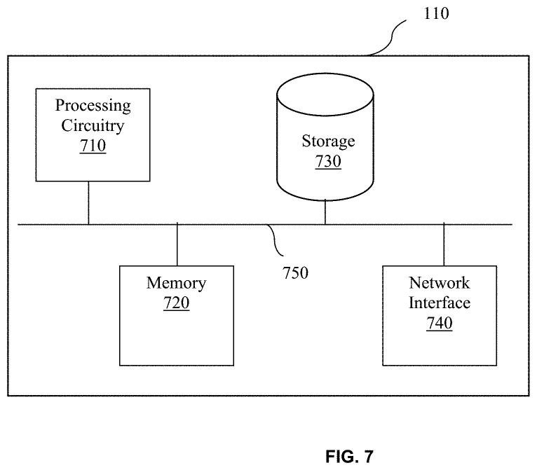

The payment system 110, depicted in detail with respect to FIG. 7, below, is a system configured to execute instructions, organize information, and otherwise process data. The payment system 110 may be configured to execute the methods described hereinbelow, other like methods, and any combination thereof. As described with respect to FIG. 5, below, the payment system 110 may include various processing, memory, networking, and other components allowing the payment system 110 to execute instructions and provide data processing. The payment system 110 may be implemented as physical hardware, as software virtualizing physical hardware, or as a combination of physical and virtualized components. The payment system 110 may be connected to the network 170 via those means described with respect to the network 170, above. Further, the payment system 110 may be deployed in a cloud computing platform, such as a public cloud, a private cloud, a hybrid cloud, or a combination thereof. In an embodiment, the payment system 110 can be realized using edge computing technologies. The various processes performed by the payment system 110 are described in greater detail hereinbelow.

According to the disclosed embodiments, the payment system 110 is configured to execute instructions for authorizing and financing transactions received from the PoS 120. The payment system 110 is configured to reduce the processing failure rate (i.e., rejecting legitimate transactions) compared to existing payment systems, thus, reducing risk and cost for users, vendors, and creditors.

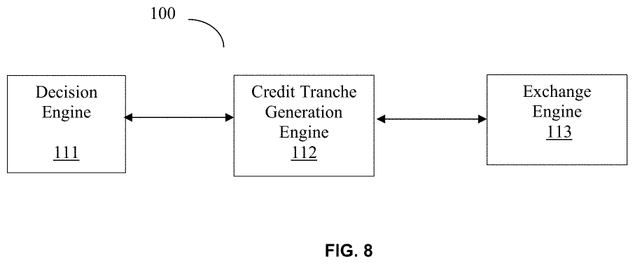

In an example embodiment, illustrated in FIG. 8, the payment system 110 includes a decision engine 111, a credit tranche generation engine 112, and an exchange engine 113. In some configurations, a payment orchestration system can be combined with the decision engine 111. The payment orchestration system is the Fintech or Bank providing the payment method for the consumer and merchant and typically responsible for authentication and assess the fraud risk. The decision engine 111 is configured to provide an assessment of the credit risk and determines to approve or reject the loan.

Each engine may be realized in hardware, software, firmware, or a combination thereof. For example, each engine may be realized as a virtual machine (or other virtual entity) that may be hosted in different locations in a cloud platform, datacenter(s), and the like. In some configurations, the exchange engine may be included in a server 140. In an embodiment, the payment system 110 can be realized using edge computing technologies.

As will be discussed in detail below, some functionality may be implemented by the decision engine 111 configured to decide if to allow or deny each payment transaction request received at a PoS 120. The credit tranche generation engine (hereinafter “tranche engine”) 112 is configured to aggregate allowed transactions and generate tranches respective thereof. Each tranche is associated with a determined risk range and the total debt of the transactions in the tranche.

A credit tranche is a credit instrument designed to organize a series of customer obligations into an instrument that is standardized as to the product specifications, such as to general credit quality, the number of transactions, face value amount of credit, and a minimum number of borrowers.

The tranche engine 112 is configured to execute processes to generate and maintain credit tranches. Specifically, the tranche engine 112 is configured to initiate a new credit tranche bucket, notifying the exchange engine 113, and securing transaction work in process funding. The tranche engine 112 is further configured to allocate transactions to a credit tranche as such transactions are processed by the decision engine 111. The allocation is based, in part, on a risk score determined for each transaction, when a transaction's score is changed, the tranche engine 112 can be configured to continuously notify the exchange engine 113.

In another embodiment, the tranche engine 112 is further configured to validate and approve credit tranches, thereby ensuring all the transactions comply with the exchange engine specifications. Once a tranche is validated, the tranche is transferred to the exchange engine.

A credit tranche 112 is a dynamic object, i.e., transactions and their attributes in the tranche may be frequently updated or changed. Therefore, a tranche engine 112 is configured to receive customer payments, allocate and guide them to the appropriate tranche, update tranche notional value, and settle payments to the tranche.

In an embodiment, credit tranches can have a fixed term or have their term be determined by reaching a critical threshold of remaining principal based on the credit instrument product specification. For example, if all loans in a tranche have to be paid within 2 years, the life cycle of that tranche would be 2 years. Upon closure of the credit tranche, the tranche engine 112 is configured to finalize and prevent additional activities related to the credit tranche and communicate to exchange engine 113 for it to distribute final cash flows to registered tranche owner through the exchange engine 113. Any remaining transactions at this time are reallocated through the credit engine 112. Financial adjustments to close the tranche will be performed by the Exchange 113.

In an embodiment, a credit tranche can be posted on a blockchain, so to allow another layer of security and management for tranches. In one configuration, when posted on a blockchain, a tranche can be associated with cryptocurrency. In an example embodiment, the cryptocurrency is a stablecoin, which is a specific implementation of the use of cryptocurrency and Blockchain for verifying and implementing the underlying assets. In another example embodiment, the cryptocurrency for realizing a credit tranche may include a smart contract.

It should be noted that a transaction in a credit tranche may include any monetary asset representing debt. Such assets include, but are not limited to, credit card transactions, car loans, mortgages, student loans, securities loans, Buy Now, Pay Later (BNPL) fintech platforms, and so on.

The exchange engine 113 is configured to broker the sale of the credit tranches generated by the tranche engine 112 to exchange members. Exchange members may stream bids for tranches of specific risk levels. There is a periodic batch auction in which all tranches created and moved to the exchange 113 since the last auction are allocated among the members by an auction algorithm. A designated exchange member (a market maker) is obligated to bid continuously, and thus provide transparency to the ecosystem. A designated exchange member will be the buyer of last resort for the credit tranche when there are no competing bidders. The exchange engine 113 continuously communicates the market bids to the engine 112 so that payment terms can be continuously adjusted to reflect the current market condition and presented to the user.

The servers 140 are systems of financial institutions, that may be configured to place a bid, receive currency, and wire currency. The servers 140 may include legacy systems, virtual servers, physical servers, and the like.

The database 150 is a data store configured to archive data permanently or semi-permanently. The database 150 may be configured to store information received from the servers 140 and the payment system 110. Further, the database 150 may be configured as a full-physical system, including exclusively physical components, as a virtualized system, including only virtualized components, or as a hybrid physical-virtual system. The database 150 may include, without limitation, local database hardware, cloud storage systems, remote storage servers, other, like, devices, and any combination thereof.

According to an embodiment, the database 150 may be configured to store or otherwise archive data relating to payment transaction requests (denied or allowed), information related to users, financial institutions, credit tranches, and the like.

In an embodiment, in order to pay for goods or services, a user may be required to make the payment through a user device 160. The user device 160 may include an application, an agent, widget, or any piece of code (hereinafter “payment app” 165) that would allow to transact with the PoS 120. The payment app 165 also monitors the activity of a user of the user device 160. For example, the activity may include payment made by the user, places visited, purchasing patterns, interactions with other services/applications installed in the user device 160, and the like.

The user device 160 may include, but is not limited to, a smartphone, a personal computer, a tablet computer, a wearable device, a smart card, and the like. The payment app 165, and thus the user device 160, can transact with the PoS 120 using technologies such as, but not limited to, near field communication, QR codes, BLE signals, cellular signals, and the like.

It should be noted that one user device 160 is shown in FIG. 1 merely for ease of the descriptions, and in a particular configuration, the payment system 110 can interact with multiple user devices and process multiple different transactions in parallel.

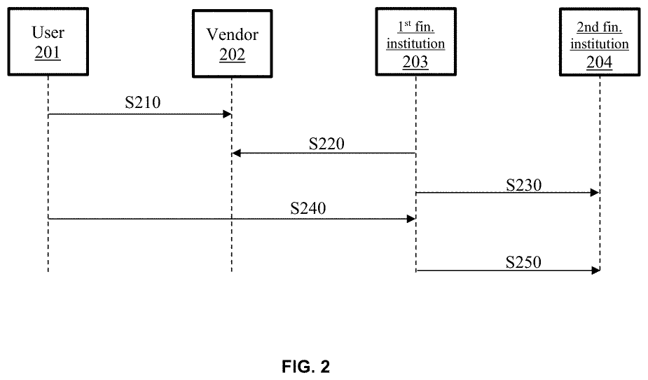

FIG. 2 is an example flow diagram illustrating the monetary transactions among various entities according to the disclosed embodiments. The monetary transactions are controlled by the payment system 110.

At S210, a user 201 initiates a payment using a payment app (e.g., app 165, FIG. 1) to a vendor 202 through a PoS (e.g., PoS 120, FIG. 1). The payment is a credit transaction, i.e., the payment app serves as a credit card. Such payment is first approved by the payment system.

At S220, a first financial institution 203 reimburses the vendor 202 for the credit transaction. In an embodiment, a financial institution 203 can be a SPV (Special Purpose Vehicle) created for this purpose. It should be noted that in a typical implementation, a number of credit transactions may be paid in a single transaction to the vendor 202.

At S230, the first financial institution 203 sells a credit tranche representing a group of credit transactions to at least one second financial institution 204 under negotiated payment terms.

At S240, the first financial institution 203 collects debit payments from users (e.g., user 201) and passes them to the Exchange 113.

At S250, a payment is made through the tranche to the second financial institution 204 from the first financial institution 203.

It should be noted that all transactions illustrated in FIG. 2 are electronic transactions that are processed by the systems, servers, software, and the like as discussed in FIG. 1. As such, no transaction shown in FIG. 2, can be performed, controlled, or supervised by a human. In fact, in a typical operational environment, there are thousands of transactions to be processed every second, thus it is impractical and impossible to be performed by humans.

It should be further noted that the steps shown in FIG. 2, are performed under the control of the payment system 110. In some configurations, the system 110 may interact with third party systems. For example, the payment system 110 may transact with a security system that can detect fraudulent transactions. The payment system 110 may further transact with third-party systems that may facilitate the collection of payments from end-users.

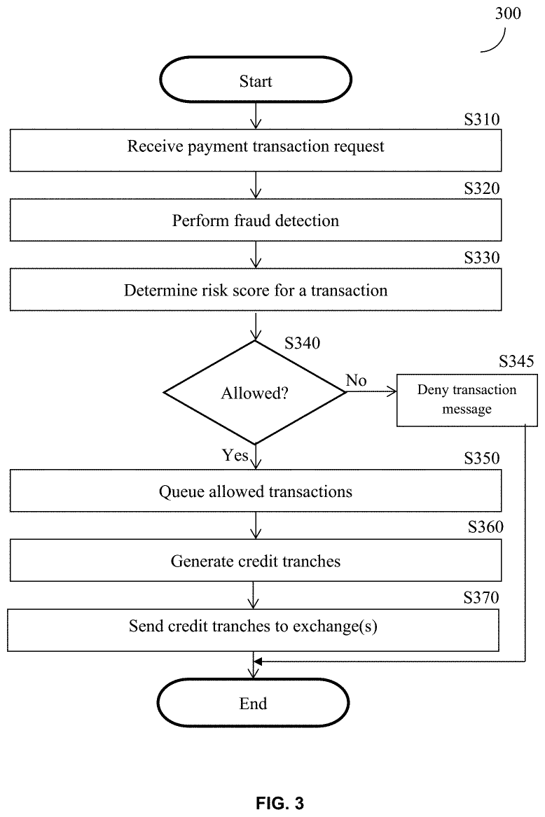

FIG. 3 is an example flowchart 300 illustrating the operation of the payment system 110 according to an embodiment.

At S310, a credit transaction approval request is received. The request may include the user information, vendor information, and requested amount and terms (e.g., installments), and other metadata. The request is initiated by a user device and may occur when a user (payer) and vendor (payee) are in the same location, at the point of sale. Alternatively, the request may occur when user and vendor are in separate locations performing an e-commerce activity.

The metadata may include a transaction time, a geolocation of user and vendor, type of the purchase, and so on. The user information includes at least a unique identifier (ID) identifying the user. The vendor information may include an identifier of the vendor, its type, and the like. The credit transaction approval request may be encrypted.

At S320, a fraud detection process is performed on the received transaction to determine if the transaction is fraudulent or not. A number of techniques are disclosed in the related art to identify such transactions and be utilized by the disclosed system. For example, a fraudulent transaction can be detected based on locations of the vendors with respect to the location of the user device. As another example, the fraudulent transactions can be detected based on history of transactions of the same user. In addition, fraudulent activity can also be detected using machine learning models configured to classify transactions based on patterns. The patterns include, for example, transaction frequency, transaction's amounts, type of purchased products/services, internal user networks activity, and the like. In an embodiment, a fraud detection is provided by a third-party application or system. To this end, at S320, a third-party system is queried with the received transaction to determine if the transaction is fraudulent.

At S330, a risk score is determined for the received credit transaction approval request. In an embodiment, the determination is based on the current risk profile of the user. Such a profile is continually learned and updated, therefore providing an accurate indication as to the likelihood that the user pays back. In some example embodiments, the current risk profile is generated by using a know your intentions (KYI) process. An initial profile is generated for the user when subscribing to the payment system. The initial profile may be based on data provided by the user (e.g., income, expenses) and credit score.

The KYI process is configured to correlate multi-dimensional data sources that utilize machine learning to predict customer intentions and optimize customer experience accurately. The method optimizes the amount and data required and prioritize resource allocation on data elements that are most relevant for improving prediction confidence levels.

The data sources being correlated include a mobile device micro-movement, social media platforms, web intelligence services, biometrics, financial transaction details, credit bureau reports, and the likes, or any combination thereof. Micro-movements includes any activity monitor on the user device (such as, web site visited, applications installed, motion information, typing speed, and so on), and information shared between applications (apps) in the user device. Social media platforms any information posted by the users on social media. Web intelligence services provide analysis of social circles. The services can covertly uncover and analyze the data flows from open source web and social networks, augmented with deep web and darknets sources. Biometrics include any biometric identifiers are the distinctive, measurable characteristics used to label and describe individuals. An additional data source is financial information on the user, such as available credit, a number of missed payments, and the like.

The various streams received from data sources are processed by a machine learning model trained to compute a risk score for the received transaction request. The machine learning model may be any of a supervision model, an unsupervised model, or a semi-supervised model.

It should be noted that fraud detection and risk score can be computed on transactions that are being processed as debit transactions.

At S340, it is checked based on the risk score and a fraud indication whether to allow the transaction. In some configuration, the fraud indication computed at FIG. 3 is factored in the risk score. The check may be based on a predefined threshold. If S330 results with a ‘yes’ answer, execution continues with S350. Otherwise, a denied message is sent to the vendor at S345. The risk score and the respective user identifier is saved in the database, such as database 150, FIG. 1 above.

In an embodiment, S310, S320, S330, and S340 are performed by the decision engine 111 discussed above. It should be noted that the decision engine 111 can be separated into different logical entities that communicate through an API.

At S350, several arrived credit transactions are collected. This may include collecting several transactions collected during a predefined time interval (e.g., 24 hours) or until a number of transactions are received. The approved credit transactions may be the same vendors or different vendors.

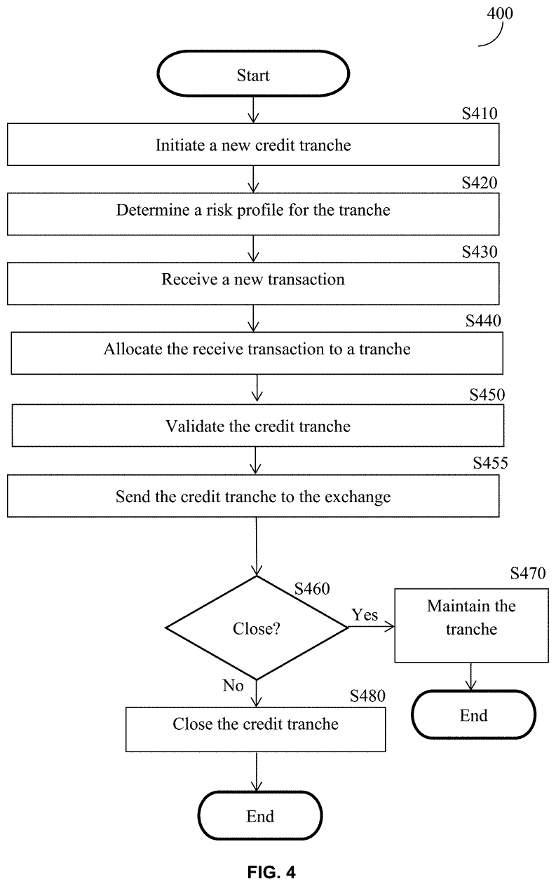

At S360, credit tranches are generated based on the collected transactions. The credit tranches create fungibility, transparency, and thus engender liquidity. A credit tranche is a collection of credit transactions with different attributes that fall within a narrow range of risk level. Each tranche is associated with a tranche ID and the value of the tranche. The face value is an accumulated amount of the debt of all transactions in a tranche. The face value is updated in real time as transactions are paid. In an embodiment, paid transactions are replaced with new credit transactions with the same risk to keep the face value constant. The operation of S360 are discussed in greater detail in FIGS. 4-6.

At S370, completed credit tranches are sent to an exchange engine. In case when there is no exchange engine the credit tranches may be sent to a predefined closed group of Funding partners. Each tranche is auctioned according based, in part, on real-time bids provided by members. The auction may be based on predefined algorithm. In an embodiment, there is at least one member required to provide bids and participate in the auction whether there are other bidders or not.

In an embodiment, the financial institution bidding or buying a tranche is different from institutions paying the vendors and approving the transactions. In another embodiments, credit tranches can be traded among members on the Exchange in a secondary market. In an embodiment, tranches may be traded in a decentralized manner using blockchain.

FIG. 4 shows an example flowchart 400 illustrating a method for generating a credit tranche according to an embodiment. The method will be described with reference to a life cycle of a single credit tranche, however, it should be appreciated that the same teachings are applicable to creating and managing multiple (e.g., thousands) credit tranches in parallel or in series.

At S410, a new credit tranche is initiated. This may happen when there is no appropriate credit tranche available to accept new validated transactions. An available tranche is a tranche that has a capacity for transactions having a risk score in the same designated range as the score of the queued transaction.

At S420, a risk profile is determined for the credit tranche. The risk profile is a percentile range (or quantile) of the risk level of the transactions included therein. The profile may be also adapted based on other factors, such as current market conditions.

At S430, a transaction is received from a decision engine. The transaction may be any asset representing debt, such as a credit card transaction, a car loan, a mortgage, a student loan, a security loan, and so on. Each transaction includes one or more of the following parameters: payer, transaction context (e.g., product, price, date, time, location, device, channel, etc.), and a transaction risk score.

At S440, a received transaction is allocated to the initiated credit tranche (or an available tranche). Specifically, S440 includes checking if there is an existing tranche that meets with a risk score queue (bucket) having the same designated risk score range as the received transaction. If only one exists, then it is further checked, if the received transaction, when allocated, either improves the demographic diversity of the open tranche, or at least, does not degrade it. The allocation of transaction ensures that there is a sufficient diversity inside the tranche. The diversity can be determined as the covariance among transactions in a tranche.

When the received transaction meets the diversity threshold, then the received transaction is placed into the open tranche. If the received transaction does not meet the diversity threshold and no other tranche meets the diversity threshold, a new tranche is opened (created at S410).

It should be noted that if the received transaction can be allocated to multiple credit tranches, the transaction is allocated to the tranche that generates the greatest demographic diversity. Once the transaction is allocated to a tranche its identifier (ID) is added as one of the transaction's parameters.

At S450, the progress of the credit tranche is monitored against the product specifications of the exchange engine (e.g., 113 on FIG. 8). When a sufficient number of transactions are placed into a tranche to meet the product specifications, the credit tranche is validated. When the credit tranche is successfully validated, the tranche certified. At S455, a certified tranche may be sent to an exchange server under the control to the exchange engine.

The process will also ensure that credit transactions (loans) of each tranche are unique and cannot be reused in other tranches. The credit engine should be able to continually notify the exchange and other parties on the completion level of each credit tranche.

At S460, it is checked if the credit tranche can be closed. If so, execution proceeds to S470; otherwise, execution continues with S480 when a tranche is closed.

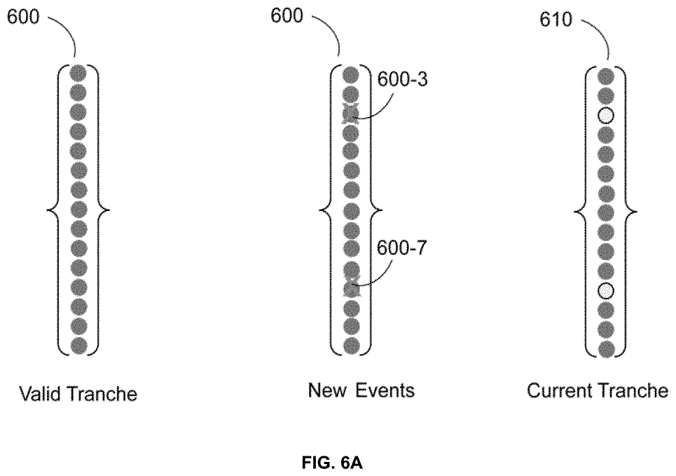

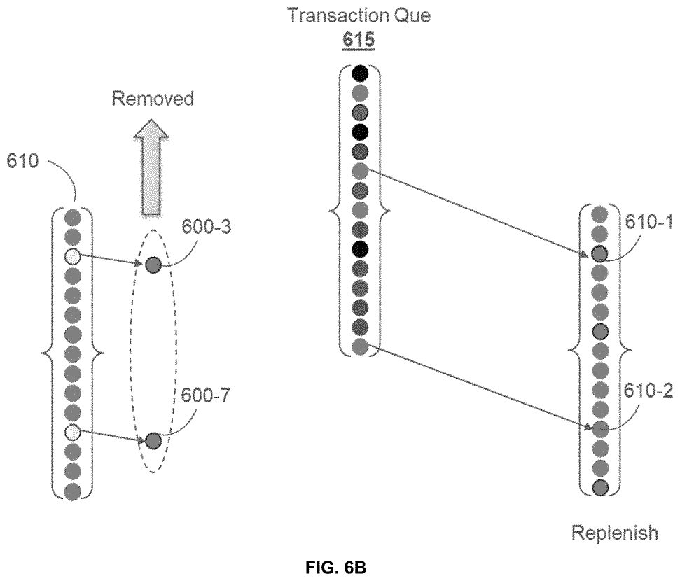

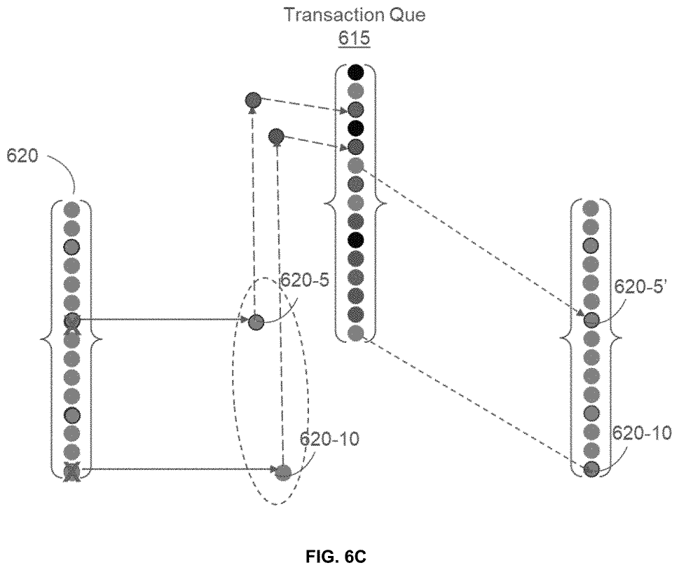

At S470 a tranche maintenance process is performed. The maintenance of tranche includes receiving payments from borrowers into the appropriate credit tranche. Each payment from a borrower is tied to all previous transactions from that borrower. If the payment is for the entirety of the debt, then each affected tranche receives its appropriate cash flow (payment) and update the notional value of each tranche. If the borrower sends a partial payment, the principal portion is be allocated among the appropriate tranches typically on a FIFO basis with respect to outstanding transactions, while the interest portion will be allocated pari passu (side-by-side) to the appropriate tranches. In an embodiment, both the interest and the principal could be allocated pari passu. It should be noted that interest payments have no effect on the tranche's notional value while principal payments do. The maintenance of tranche is further discussed in FIG. 6.

At S480, the tranche is closed. The conditions for closing a tranche may include any one of: when the notional value of the tranche is zero, when the notional value is below a predefined value (that may be by, for example, credit security product specifications), or when a tranche's age is over a predefined value (defined in security product specifications). The tranche's age is measured since the creation of the tranche. A notional value is used to value the underlying transactions in the tranche. As transactions are paid, their respective values become zero.

Closing the credit tranche is performed according to the product specification including checking if there are any transactions remain in the credit tranche, re-allocating such transactions to other available transaction based on transactions current scores, paying off the tranche, and delisting the tranche from the exchange server. The remaining transactions at the time of the tranche closure are placed into the queue in S350 and allocated based on current risk scores to open tranches. The final settlement value to the tranche owner is determined via the Exchange auction process.

In one embodiment, credit tranches can be managed over a Blockchain network, such as Ethereum, and realized as stablecoin, a smart contract, or any other type of cryptocurrency. Here, a form or cryptocurrency is generated or otherwise computed for each credit tranche.

In an example embodiment, the credit tranche engine may assemble the tranche and verify that the loans exist and verify the ownership. The exchange may create cryptocurrency that would be exchangeable in some integer multiple of tranches.

In a blockchain embodiment, the proof of asset function is performed by the tranche system (or any other function in the payment system 110, FIG. 1). This includes verifying payment from the borrower and making payments to the lenders. The Blockchain would contain the registration of the tranche, the chain of digital signatures, and the verification of ownership of the loans.

It should be noted that utilizing blockchain to manage the tranche provides a number of advantages, such as credit market democratization, improved security and verification of ownership, and compliance with financial regulations.

FIG. 5 show an example diagram 500 illustrating the generation of credit tranches according to an embodiment. First, a transaction queue (or bucket) 510 is filled with approved cited transactions. Each transaction that is in the queue 510 includes transaction metadata listing the risk score of the transaction, user and vendor information, time, price, quantity, items, channels, and the like.

Then, the queued credit transactions are distributed into credit tranches 520-1 through 520-t (where ‘t’ is an integer greater than 1). A credit tranche can be viewed as a unified set of “portfolio of loans” sharing the same quality of loan. In an embodiment, credit transactions having the same risk score (exact number or a range) are associated with the same credit tranche. For example, transactions with a risk score ‘1’ would be associated with tranche 520-1 and transactions with a risk score ‘10’ would be associated with tranche 520-2. Considering the transaction risker with a higher score, then the transactions in the tranche 520-1 represent a less risky loan than those in tranche 520-2. A score can be associated with the entire tranche 520-1 and be based on external factors, such as a current employment rate, a current market, natural disasters, current political events, and the like. The tranche score is not determined solely based on users submitting the transactions.

The placement of transactions in validated tranches 530-1 through 530-r after processing each transaction is based in part on its risk score. In an embodiment, a validated tranche 530-1, 530-r further includes the face value of each tranche, i.e., the total of loan (debt) value represented by the transactions in the tranche.

In an embodiment, for each validated tranche 530-1, 530-r is a unique value representing a traded financial instrument that can be traded. Such value is generated in real time and fed to the servers 140 in real time to financial institutions to bid or trade the validated tranches. For example, values can be changed if transactions are removed from the tranche (for example, when paid) or when new transactions are added. In some embodiment, transactions can be moved from tranche to tranche.

It should be noted that the credit tranches provide standardized financial instruments that can be managed, monitored, and traded in real-time. Further, it ensures that credit transactions (loans) of each tranche are unique and cannot be reused in other tranches.

FIGS. 6A, 6B, and 6C are example diagrams illustrating the maintenance of credit tranche according to an embodiment.

A credit tranche can be changed or modified upon multiple events: for example, risk score changes or loan payments. Upon receiving a trigger that one of these events occur. A risk change event is triggered when a risk score of a transaction in a tranche change. This event is provided by the decision engine. A loan payment event is trigged when a loan (or a portion thereof), and/or interest are paid by the consumers. This event is provided by the exchange engine.

As demonstrated in FIG. 6A, a credit tranche 600 includes transactions 600-1 through 600-10, where transactions 600-3 and 600-7 are paid. The paid transactions are marked as paid (in full or partial) from tranche 600 resulting with a tranche 610 having a diminished nominal value.

In certain embodiments, the product specifications created by the exchange may require maintaining a fixed face value of a tranche, e.g., tranche 610. In this case, as illustrated in FIG. 6B, as new transactions are received (from a transaction queue 615), such transactions (e.g., 610-1 and 610-2) are allocated to the credit tranche 610 to replenish the tranche 610 with new transactions having the same loan value as the paid transactions (e.g., transactions 600-3 and 600-7, FIG. 6A).

FIG. 6C demonstrates the maintenance of a credit tranche when a risk change event is triggered. In this embodiment, when a risk score of one or more transactions is changed, e.g., and transactions 620-5, and 620-10 in the tranche had their risk scores changed. These transactions are removed from the credit tranche 620, where the transactions 620-5, and 620-10 are placed in a transaction queue 615 to be allocated to a new or a different tranche.

Later, as new transactions are received, such transactions are allocated to the credit tranche 620 to replenish the tranche 620 with new transactions (e.g., 620-5 and 620-10) having same risk score as current transactions. That is, the overall risk profile of the tranche 620 does not change.

FIG. 7 is an example block diagram of the payment system 110 according to an embodiment. The payment system 110 includes a processing circuitry 710 coupled to a memory 720, a storage 730, and a network interface 740. In an embodiment, the components of the payment system 110 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 720 may be volatile (e.g., RAM, etc.), non-volatile (e.g., ROM, flash memory, etc.), or a combination thereof. In one configuration, computer readable instructions to implement one or more embodiments disclosed herein may be stored in the storage 730.

In another embodiment, the memory 720 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, CD-ROM, Digital Versatile Disks (DVDs), or any other medium which can be used to store the desired information.

The network interface 740 allows the payment system 110 to communicate with the exchange servers 140 and the like. Further, the network interface 740 allows the system 110 to communicate with the database 150 for the purpose of collecting information regarding the product.

It should be understood that the embodiments described herein are not limited to the specific architecture illustrated in FIG. 7, and other architectures may be equally used without departing from the scope of the disclosed embodiments.

The embodiments disclosed herein can be implemented as hardware, firmware, software, or any combination thereof. The application program may be uploaded to, and executed by, a machine comprising any suitable architecture. Preferably, the machine is implemented on a computer platform having hardware such as one or more central processing units (“CPUs”), a memory, and input/output interfaces.

The computer platform may also include an operating system and microinstruction code. The various processes and functions described herein may be either part of the microinstruction code or part of the application program, or any combination thereof, which may be executed by a CPU, whether or not such computer or processor is explicitly shown.

In addition, various other peripheral units may be connected to the computer platform, such as an additional network fabric, storage unit, and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

What is claimed is:

1. A method for generating a transferable tranche, comprising:
receiving at least one electronic transaction request from a user;
computing a risk score of the at least one electronic transaction;
responsive to the at least one electronic transaction being allowed based on the risk score, placing the at least one electronic transaction into a transferable transactions queue; and
generating a transferable tranche for allocation of the queued electronic transactions.

2. The method of claim 1, further comprising:
determining risk scores for the electronic transactions based on a risk profile of the user, wherein the risk profile is dynamically updated.

3. The method of claim 2, further comprising:
responsive to closing of the transferable tranche, checking for transactions remaining in the transferable tranche and re-allocating the remaining transactions to at least one open transferable tranche based on the risk scores.

4. The method of claim 1, further comprising:
initiating a new transferable tranche responsive to unavailability of transferable tranches to be allocated for the queued electronic transaction.

5. The method of claim 4, further comprising:
determining a risk profile for the new transferable tranche, wherein the risk profile is based on at least a percentile range of the risk level of the queued electronic transaction to be allocated to the new transferable tranche.

6. The method of claim 5, further comprising:
validating the new transferable tranche responsive to a number of transactions being placed into the new transferable tranche that matches a product specification.

7. The method of claim 6, further comprising:
certifying the new transferable tranche upon a successful validation and sending the certified new transferable tranche to an exchange server.

8. The method of claim 6, wherein the validating of the new transferable tranche further comprises:
verifying that electronic transactions placed into the new transferable tranche are unique and are not reusable in other tranches.

9. The method of claim 1, wherein the electronic transaction is a payment transaction submitted by a user and wherein the transferable tranche is a credit tranche.

10. A non-transitory computer readable medium having stored thereon instructions for causing a processing circuitry to perform a process for generating a transferable tranche, the process comprising:
receiving at least one electronic transaction request from a user;
computing a risk score of the at least one electronic transaction;
responsive to the at least one electronic transaction being allowed based on the risk score, placing the at least one electronic transaction into an allowed transactions queue; and
generating a transferable tranche for allocation of the queued electronic transactions.

11. A system for generating a transferable tranche, comprising:
a processing circuitry; and
a memory, the memory containing instructions that, when executed by the processing circuitry, configure the system to:
receive at least one electronic transaction request from a user;
calculate a risk score of the at least one electronic transaction;
responsive to the at least one electronic transaction being allowed based on the risk score, place the at least one electronic transaction into an allowed transactions queue; and
generate a transferable tranche for allocation of the queued electronic transactions.

12. The system of claim 11, further comprising the instructions that, when executed by the processing circuitry, configure the system to determine risk scores for the electronic transactions based on a risk profile of the user, wherein the risk profile is dynamically updated.

13. The system of claim 12, further comprising the instructions that, when executed by the processing circuitry, configure the system to, responsive to closing of the transferable tranche, check for transactions remaining in the transferable tranche and re-allocate the remaining transactions to at least one open transferable tranche based on the risk scores.

14. The system of claim 11, further comprising the instructions that, when executed by the processing circuitry, configure the system to initiate a new transferable tranche responsive to unavailability of transferable tranches to be allocated for the queued electronic transaction.

15. The system of claim 14, further comprising the instructions that, when executed by the processing circuitry, configure the system to determining a risk profile for the new transferable tranche, wherein the risk profile is based on at least a percentile range of the risk level of the queued electronic transaction to be allocated to the new transferable tranche.

16. The system of claim 14, further comprising the instructions that, when executed by the processing circuitry, configure the system to validate the new transferable tranche responsive to a number of transactions being placed into the new transferable tranche that matches a product specification.

17. The system of claim 16, further comprising the instructions that, when executed by the processing circuitry, configure the system to certify the new transferable tranche upon a successful validation and to send the certified new transferable tranche to an exchange server.

18. The system of claim 16, wherein the validating of the new transferable tranche comprises verifying that the transactions placed into the new transferable tranche are unique and are not reusable in other tranches.

19. The system of claim 16, further comprising the instructions that, when executed by the processing circuitry, configure the system to post the validated new transferable tranche onto a blockchain.

20. The system of claim 11, wherein the electronic transaction is a payment transaction submitted by a user and wherein the transferable tranche is a credit tranche.
